(19) United States
(12) Patent Application Publication
(10) Pub. No.: US 2026/0291327 A1
(43) Pub. Date: Sep. 24, 2026

(54) MECHANICALLY COUPLED HYBRID GENERATOR

(71) Applicant: Alliance North America, Inc, Henderson, NV (US)

(72) Inventors: Travis Waineo, Henderson, NV (US); Michael Yin, Henderson, NV (US); Jeremy A. Goddard, Henderson, NV (US); Thomas J. Caterina, Sun Lakes, AZ (US); Michael F. Niemela, Henderson, NV (US); Kevin Speach, Henderson, NV (US); Gregory McFadden, Las Vegas, NV (US); Warren J. Krettek, Henderson, NV (US)

(21) Appl. No.: 19/458,060

(22) Filed: Jan. 23, 2026

Related U.S. Application Data
(60) Provisional application No. 63/769,507, filed on Mar. 10, 2025.

(51) Int. Cl. H02K 7/108; H02K 7/02; H02K 7/116; H02K 7/18; H02K 7/20; H02K 11/00; H02P 29/00

(52) U.S. Cl. CPC H02K 7/108; H02K 7/02; H02K 7/116; H02K 7/1815; H02K 7/20; H02K 11/0094; H02P 29/0027

(57) ABSTRACT

A hybrid generator includes an engine, a clutch, a motor, an alternator, a motor controller, and a battery. When the engine is running, the engine rotates the motor, which rotates the alternator, which supplies power to a load. When the motor is running, the battery, via the motor controller, drives the motor to rotate the alternator. The system selectively rotates the alternator using the engine or battery power. The system will use battery power until the battery reaches a minimal state of charge. Thereafter, the engine is started and the clutch engaged to power the load and charge the battery to a maximum state of charge. At which point, the clutch is disengaged, the engine stopped, and the system reverts to battery power. Bypass modes can be used that power the load using engine power due to efficiency, system faults, extreme environmental conditions, or peak loads.

### CROSS REFERENCE TO RELATED APPLICATION

The present application claims the benefit of U.S. provisional application Ser. No. 63/769,507, filed Mar. 10, 2025, which is hereby incorporated herein by reference in its entirety.

### FIELD OF THE INVENTION

The present invention is directed to power generation, battery systems, system controls, and battery storage systems in combination with generators in mobile and stationary applications.

### BACKGROUND OF THE INVENTION

Generators are often driven by engines, such as diesel engines, and other engines using a variety of fuels, e.g., propane, natural gas, gasoline, biodiesel, and hydrogen.

### SUMMARY OF THE INVENTION

Embodiments of the present invention provide a hybrid generation system for efficiently powering loads ranging from very low up to the maximum rated load of the generator. Example engines may be operated by consuming a variety of fuel sources, for example, diesel, propane, natural gas, gasoline, biodiesel, and hydrogen. A hybrid generator improves the efficiency of an engine-powered generator by running the engine (of the generator) at or near its optimal load and storing unused power in batteries. When the batteries have reached a maximum state of charge, the engine can be turned off and the resulting energy stored in the batteries can be used to power the load (e.g., by powering an electric motor to rotate the alternator of the generator).

In an aspect of the present invention, the hybrid generator is an engine mechanically coupled with an electric motor and an alternator. The hybrid generator system may include an engine, a clutching mechanism, one or more electric motors, one or more motor controllers, an alternator, one or more controllers, and/or one or more batteries. The electric motor and alternator are coupled to an engine, e.g., diesel, propane, turbine, or fuel agnostic engine, via either an electronically controlled, or a mechanically actuated clutching mechanism. The motor controller is a bi-directional device that can either power the electric motor using the battery or charge the battery using the electric motor as a power source. The hybrid generator is configured to keep the alternator always rotating at a constant speed selectively using either the engine or the electric motor, motor controller, and batteries to rotate the alternator. When using the engine to rotate the alternator, the system operates in a charging mode using excess engine power to charge the battery. The system operates in the charging mode until the battery reaches a maximum state of charge, at which point the clutching mechanism is disengaged, the engine is turned off, and the system operates in a discharge mode until reaching a minimum state of charge. When the batteries reach the minimum state of charge, the engine is re-started, the clutching mechanism is engaged, and the system re-enters the charging mode.

In an aspect of the present invention, an exemplary hybrid generator includes an engine, a clutching mechanism, an electric motor, an alternator, a bidirectional motor controller, and one or more batteries. The engine is coupled to the electric motor via the clutching mechanism, and with the electric motor coupled to the alternator, such that when the engine is running and the clutch is engaged, the electric motor and the alternator will be rotated by the engine. In this mode the engine/alternator powers the load and via the electric motor/motor controller, charges the batteries. When the battery is fully charged, the engine can be turned off, the clutching mechanism disengaged, and the electric motor powered by the battery pack rotates the alternator, powering the load. The battery will continue running the electric motor until the battery reaches a lower charge threshold. When the battery is depleted, the engine will be restarted to power the load and recharge the battery (by rotating the electric motor).

In yet another aspect of the present invention, the hybrid generator is configured to work with any fuel-type engine, such as propane, natural gas, gasoline, ethanol, biodiesel, or hydrogen. In aspects of the present invention, the hybrid generator is configured to work with any type of engine (e.g., internal combustion, turbine engine, and the like).

In an aspect of the present invention, the parallel hybrid generator includes one or more controllers for controlling the operation of the engine, the motor, the clutching mechanism, the bidirectional motor controller, and the one or more batteries.

Thus, exemplary embodiments of the present invention improve the efficiency of an engine and alternator assembly (e.g., a diesel generator) with the inclusion of a clutching mechanism, electric motor, and alternator with the clutching mechanism arranged between the engine and the electric motor/alternator. With the inclusion of a right-angle electric motor or a gearbox between the engine and the electric motor, the hybrid generator components can be arranged in a variety of different configurations depending on the footprint requirements or use needs of a user. Regardless of the arrangement between the engine, electric motor, and alternator, when the engine is running, the electric motor will be rotated by the engine, and a voltage output produced to charge a battery (via a bidirectional motor controller). When the engine is running and rotating the electric motor, the alternator will also be rotating producing a power output for a load. When the battery is fully charged, the engine can be turned off and decoupled from the electric motor and alternator when a clutching mechanism between the engine and the electric motor and alternator is disengaged. With the engine turned off and the clutching mechanism disengaged, the battery will be used to power the electric motor, which is used to rotate the alternator to power the load. The electric motor can be used to rotate the alternator to power the load until the battery's charge reaches a low power threshold (e.g., 10% state of charge). When the battery reaches a low state of charge, the engine is restarted, its rotational speed is matched to the electric motor and the clutching mechanism will be engaged. With the engine running and the clutching mechanism engaged, the electric motor (rotated by the engine) will begin recharging the battery. Thus, the alternator will be rotated to produce power to a load by either the engine or the electric motor.

These and other objects, advantages, purposes, and features of the present invention will become apparent upon review of the following specification in conjunction with the drawings.

### BRIEF DESCRIPTION OF THE DRAWINGS

FIG. 1A is a block diagram illustrating an exemplary hybrid generator with an engine mechanically coupled via a clutching mechanism to an electric motor and an alternator, with the electric motor electrically coupled to a motor controller and batteries in accordance with the present invention;

FIG. 1B is a block diagram illustrating another example implementation of the hybrid generator in accordance with aspects of the present invention;

FIG. 1C is a block diagram illustrating another example implementation of the hybrid generator in accordance with the present invention;

FIG. 1D is a block diagram illustrating another example implementation of the hybrid generator powered by a gas turbine in accordance with the present invention;

FIG. 2A is a block diagram illustrating another example implementation of the hybrid generator incorporating a single output gearbox between the engine, electric motor, and alternator in accordance with the present invention;

FIG. 2B is a block diagram illustrating another example implementation of the hybrid generator incorporating a single output gearbox between the engine, electric motor, and alternator in accordance with the present invention;

FIG. 2C is a block diagram illustrating another example implementation of the hybrid generator incorporating a single output gearbox between the engine, electric motor, and alternator in accordance with the present invention;

FIG. 2D is a block diagram illustrating another example implementation of the hybrid generator incorporating a single output gearbox between the engine, electric motor, and alternator in accordance with the present invention;

FIG. 2E is a block diagram illustrating another example implementation of the hybrid generator incorporating a chain drive in accordance with the present invention;

FIG. 2F is a block diagram illustrating another example implementation of the hybrid generator incorporating a chain drive in accordance with the present invention;

FIG. 2G is a block diagram illustrating another example implementation of the hybrid generator incorporating a belt drive in accordance with the present invention;

FIG. 2H is a block diagram illustrating another example implementation of the hybrid generator incorporating a belt drive in accordance with the present invention;

FIG. 3A is a block diagram illustrating another example implementation of the hybrid generator incorporating a dual output gearbox between the engine, electric motor, and alternator in accordance with the present invention;

FIG. 3B is a block diagram illustrating another example implementation of the hybrid generator incorporating a dual output gearbox between the engine, electric motor, and alternator in accordance with the present invention;

FIG. 4A is a block diagram illustrating exemplary gear reducer/overdrives in accordance with the present invention;

FIG. 4B is a block diagram illustrating another exemplary embodiment that incorporates gear reducer/overdrives in accordance with the present invention;

FIG. 4C is a block diagram illustrating yet another exemplary embodiment that incorporates gear reducer/overdrives in accordance with the present invention;

FIG. 5A is a block diagram illustrating an exemplary two or more electric motors in accordance with the present invention;

FIG. 5B is a block diagram illustrating another exemplary two or more electric motors in accordance with the present invention;

FIG. 5C is a block diagram illustrating yet another exemplary two or more electric motors in accordance with the present invention;

FIG. 6A is a block diagram illustrating an exemplary inertial energy storage flywheel in accordance with the present invention;

FIG. 6B is a block diagram illustrating another exemplary inertial energy storage flywheel in accordance with the present invention;

FIG. 6C is a block diagram illustrating yet another exemplary inertial energy storage flywheel in accordance with the present invention;

FIG. 7 is a block diagram illustrating an exemplary embodiment that incorporates multiple electric motors and a planetary gearbox in accordance with the present invention;

FIG. 8A is a block diagram illustrating an alternative packaging configuration for the electric motor, motor controller, and clutching mechanism in accordance with the present invention;

FIG. 8B is a block diagram illustrating another alternative packaging configuration for the electric motor, motor controller, and clutching mechanism in accordance with the present invention;

FIG. 8C is a block diagram illustrating yet another alternative packaging configuration for the electric motor, motor controller, and clutching mechanism in accordance with the present invention;

FIG. 8D is a block diagram illustrating yet another alternative packaging configuration for the electric motor, motor controller, and clutching mechanism in accordance with the present invention;

FIG. 8E is a block diagram illustrating yet another alternative packaging configuration for the electric motor, motor controller, batteries, and clutching mechanism in accordance with the present invention;

FIG. 9 is a block diagram illustrating an exemplary embodiment that incorporates one or more external batteries in accordance with the present invention;

FIG. 10 is a block diagram illustrating an exemplary embodiment that incorporates an external super capacitor in accordance with the present invention;

FIG. 11 is a block diagram illustrating an exemplary embodiment that incorporates a clutching mechanism between the engine assembly and electric motor and a clutching mechanism between the electric motor and an alternator in accordance with the present invention;

FIG. 12A is a block diagram illustrating operation of the hybrid generator in an exemplary discharge mode in accordance with the present invention;

FIG. 12B is a block diagram illustrating operation of the hybrid generator in an exemplary charge mode in accordance with the present invention;

FIG. 12C is a block diagram illustrating operation of the hybrid generator in an exemplary peak power mode in accordance with the present invention;

FIG. 12D is a block diagram illustrating operation of the hybrid generator in an exemplary fault bypass mode in accordance with the present invention;

FIG. 12E is a block diagram illustrating operation of the hybrid generator in an exemplary environmental conditions bypass mode in accordance with the present invention;

FIG. 13 is a block diagram illustrating a standby process for an exemplary embodiment of the hybrid generator that incorporates an automatic transfer switch for switching a load from utility power to backup generator power in accordance with the present invention;

FIG. 14 is a flow diagram illustrating steps to a method for starting the hybrid generator following a normal startup procedure in accordance with the present invention; and

FIG. 15 is a flow diagram illustrating steps to a method for starting the hybrid generator following an alternative startup procedure in accordance with the present invention.

### DESCRIPTION OF THE PREFERRED EMBODIMENTS

Referring to the drawings and the illustrative embodiments depicted therein, a hybrid generator provides for the elimination or reduction of loading issues on engine driven generators and a more efficient supply of power to a load from the alternator mechanically coupled to both an engine and an electric motor. Such engines may be powered by a variety of fuels, for example, diesel, propane, natural gas, gasoline, biodiesel, and hydrogen. The engines include, for example, exemplary diesel engines suitable for driving generators (alternators), such as, for example, EPA Tier 4F certified or other similarly compliant diesel engine driven mobile generators (as well as Stage 5 or higher). The engines may be configured in a variety of options, such as internal combustion engines, turbines, and the like. Such electric motors may be configured as AC or DC motors and driven by a battery source via a bidirectional motor controller. It is understood that a “bidirectional” motor controller, when paired with an AC motor, is configured to output DC voltage when operating in one direction (i.e., operating in one direction), and output AC voltage when outputting in the opposition direction (i.e., operating in the opposite direction). Whereas the “bidirectional” motor controller provides DC to DC conversion with different voltages when paired with a DC motor. The hybrid generator also provides for the powering down of the diesel engine while the batteries of the hybrid generator provide power. As described herein, battery power (via a bidirectional motor controller) is used to energize the electric motor mechanically coupled to the alternator and thereby supply power from the alternator to the load. Exemplary hybrid generators utilize one or more electric motors, one or more motor controllers, and the components of the hybrid generator may be configured in a variety of different arrangements depending on needs and desirability.

When properly loaded, a diesel engine provides an efficient driver for a generator. When lightly loaded, diesel engines can be inefficient and susceptible to wet stacking (i.e., when unburnt diesel fuel passes into the diesel exhaust system and produces an oily residue). Wet stacking happens when a diesel engine is running at a low percentage or proportion of its capacity. For example, a diesel engine coupled to a generator is susceptible to wet stacking when the generator it is driving has no load or only a minimal load coupled to it; in addition, the generator operates less efficiently (more fuel is consumed per kwh produced versus an optimally loaded generator). When the generator is operating with no load or only a minimal load, the diesel engine is operating in an inefficient manner, resulting in the risk of wet stacking because the diesel engine is not at a proper operating temperature (allowing unburnt fuel to escape into the diesel exhaust system). Diesel engines are most efficient when they are running at a sufficient percentage or proportion of their full capacity. When a diesel engine is running under a sufficient load, the diesel engine can run at an optimum operating temperature. Generators used to power electrical equipment typically see variable loads through their normal usage intervals. To aid in the prevention of wet stacking of diesel engines coupled to generators, dummy loads or load banks can be applied to their generators.

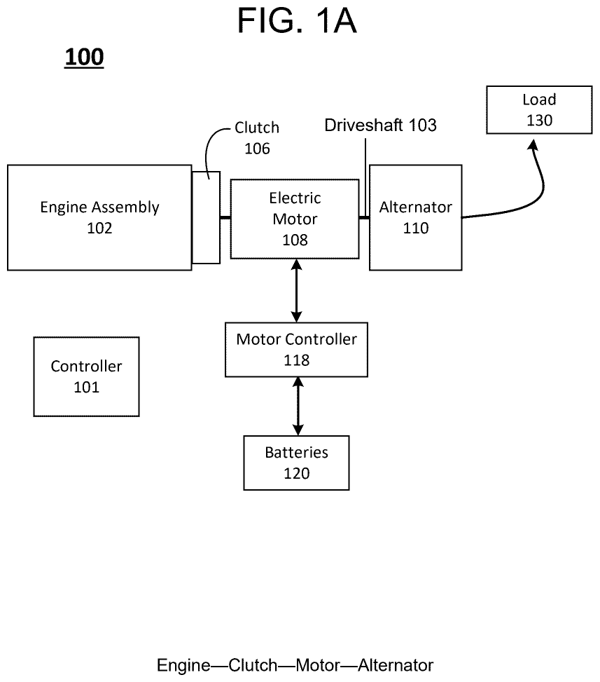

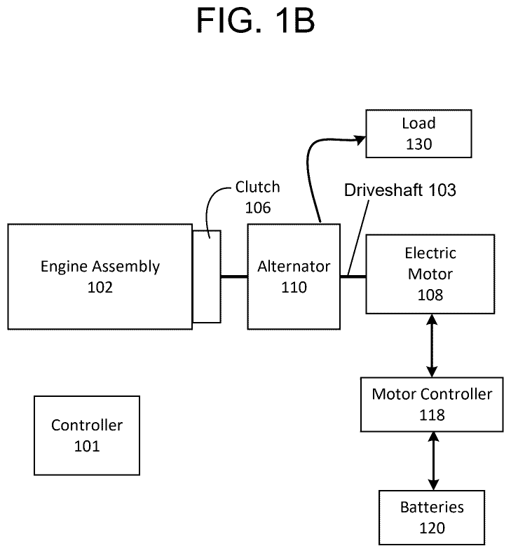

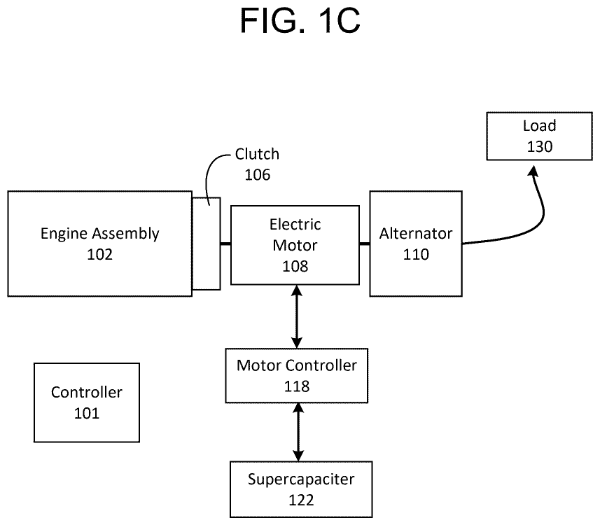

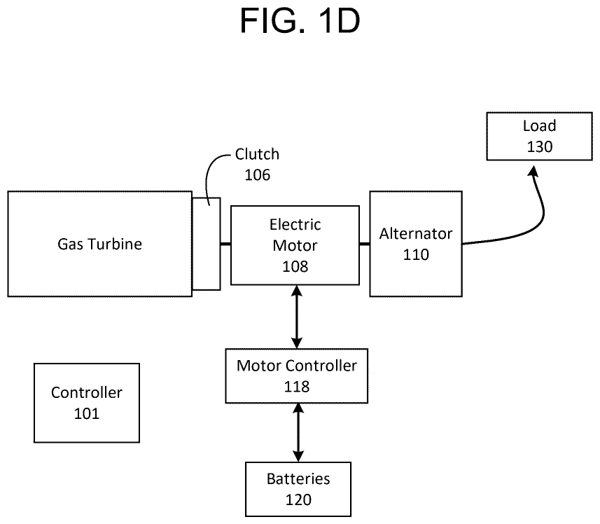

As described herein, exemplary embodiments of a hybrid generator 100 provide for an engine-generator system that outputs AC power to a load (e.g., load 130) at a desired voltage and frequency (see FIG. 1A). The hybrid generator 100 includes an engine (e.g., engine 102) configured to run at a desired revolutions per minute (RPM) needed to ensure a mechanically-coupled alternator (e.g., alternator 110) is moving or rotating at a rotational rate (RPM) to produce the desired voltage and frequency (e.g., 50, 60, 400 Hz) needed to generate the desired alternating current (AC) power. The AC output of the alternator 110 may be, for example, 120 volts alternating current (VAC), 208 VAC, 480 VAC, 240 VAC or 600 VAC power. As illustrated and discussed herein, the engine 102 is coupled to an electric motor 108 and the alternator 110 via an electrically controlled or mechanically actuated (over-running) clutching mechanism 106. In one embodiment, the clutching mechanism (e.g., clutch 106) is electrically controlled by a controller 101. In one embodiment, the components (e.g., engine 102, clutch 106, electric motor 108, and alternator 110) are directly mechanically coupled to each other. In another embodiment, the components are mechanically coupled with the use of a driveshaft or driveline (e.g., driveshaft 103) (see FIGS. 1A and 1B). In another embodiment, the components are mechanically coupled using a combination of direct coupling and a driveshaft (e.g., driveshaft 103).

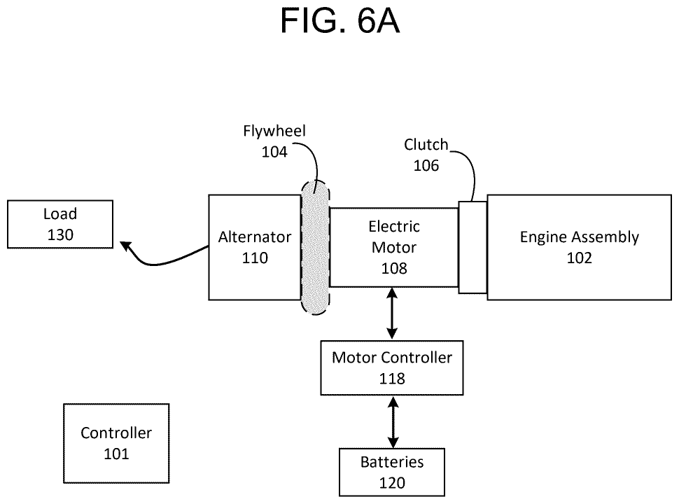

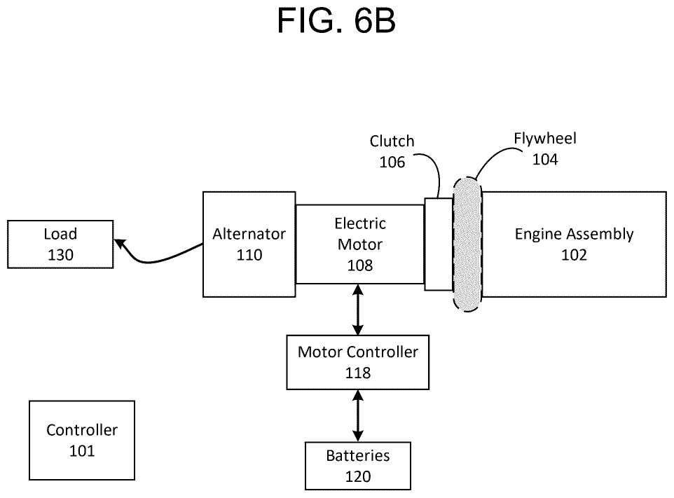

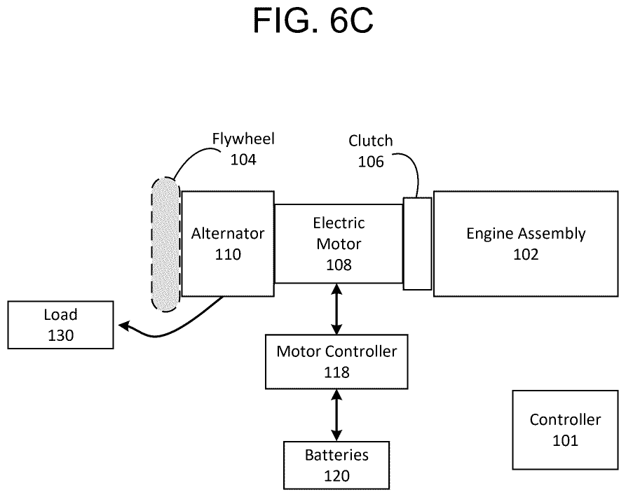

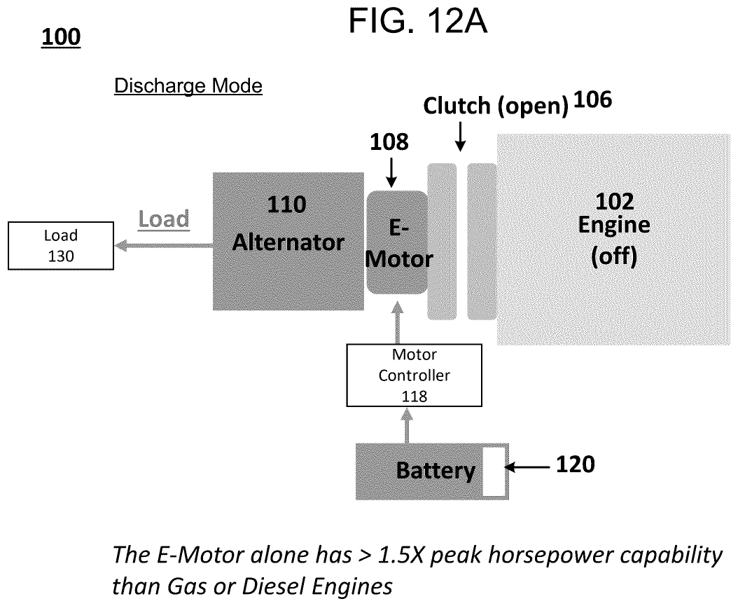

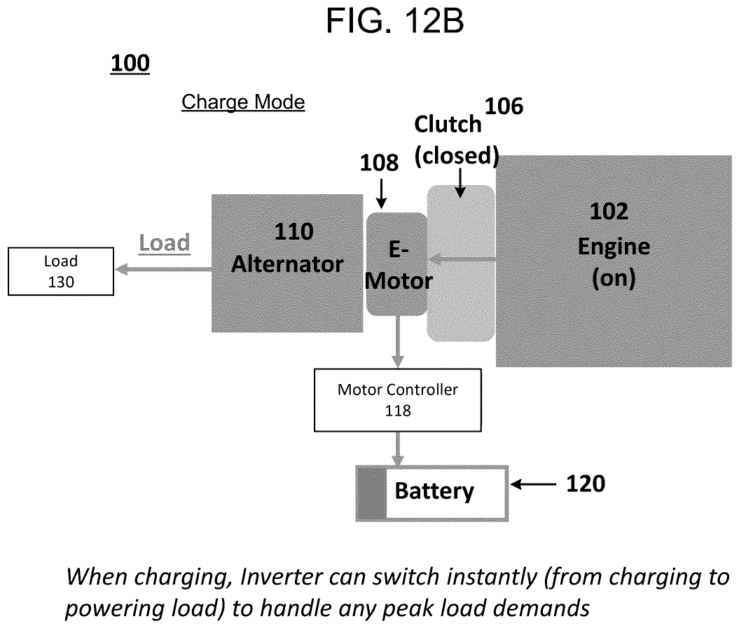

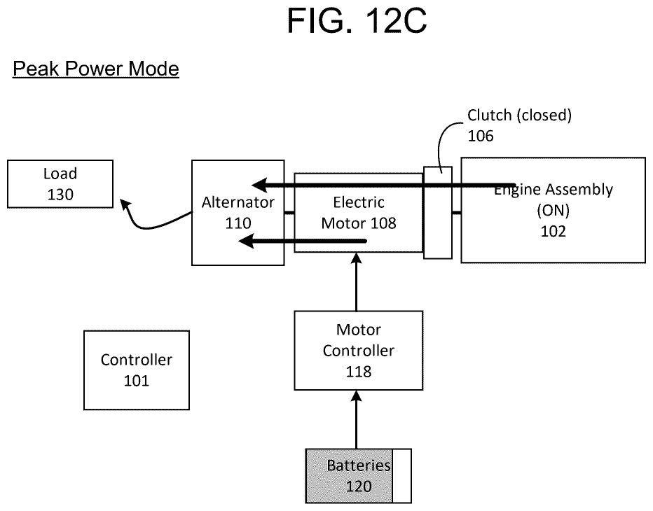

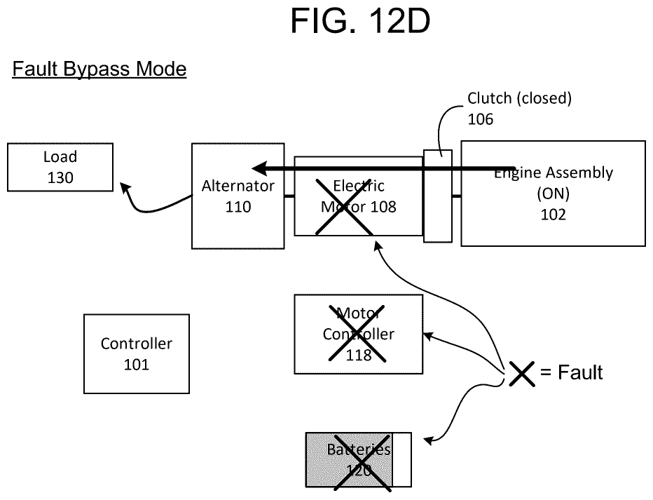

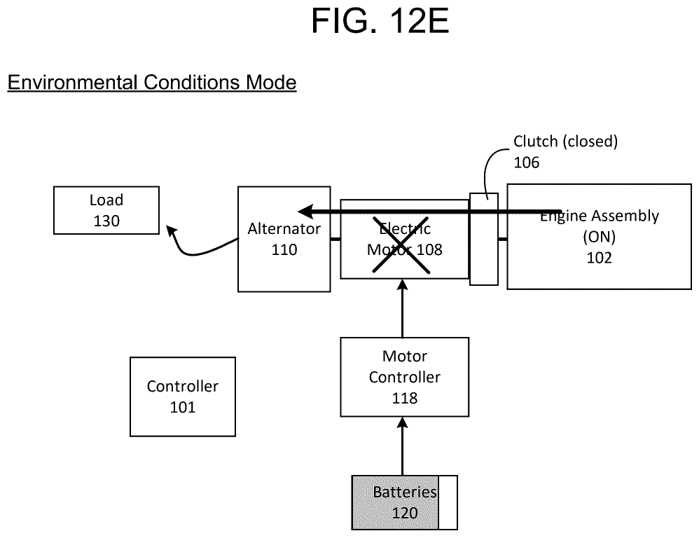

Referring to FIGS. 1A and 1B, an exemplary hybrid generator 100 includes an alternator 110 that is attached to an electric motor 108 and a clutching mechanism 106 (which may also be referred to a clutch 106). The clutching mechanism 106 may engage or disenage with a flywheel 104 on the engine 102. In some embodiments, the flywheel 104 may be a part of the engine 102 or coupled to the engine 102 (see FIGS. 6A, 6B, and 6C). As described herein, the hybrid generator 100 can power a load (e.g., load 130) with the engine 102 off and the clutch 104 disengaged, such that the electric motor 108, while powered by a battery 120 output, will move (e.g., rotate) the alternator 110 to produce the desired voltage and frequency (see FIG. 12A). Likewise, the hybrid generator 100 can power the load 130 with the engine 102 running and the clutch 106 engaged/closed. When the engine 102 is running and the clutch 106 is engaged/closed, the hybrid generator 100 can power the load 130 while also charging the batteries 108 (see FIG. 12B). As illustrated in FIGS. 1A and 1B, when the engine 102 is running and the clutch 106 is engaged, the engine 102 will be mechanically coupled to the electric motor 108 (which is mechanically coupled to the alternator 110). By the engine 102 rotating the electric motor 108, an electrical power is generated by the electric motor 108 which is used to recharge the batteries 120 (via a motor controller 118). As discussed herein, with the electric motor 108 rotating the alternator 110 (when powered by the batteries 120), backup power can be provided to a load 130 when grid power is lost even while the engine 102 is warming up and preparing to provide the needed backup power after the grid power loss.

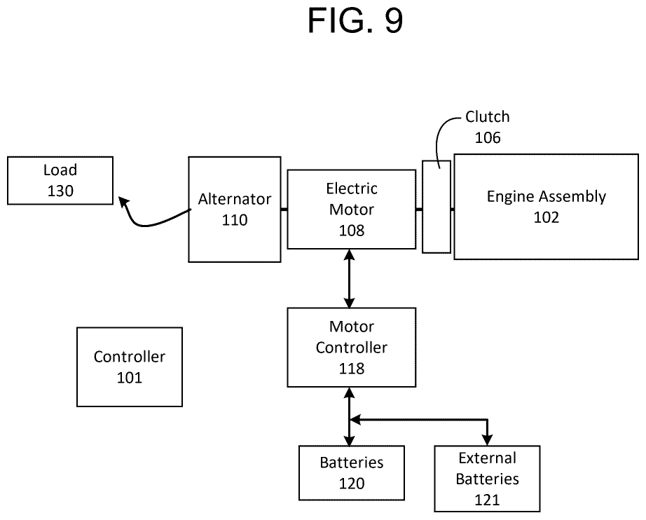

Referring to FIGS. 1C, 1D, 9, and 10, an exemplary hybrid generator embodiment 100 may optionally include one or more supercapacitors 122, in place of, or in addition to the batteries. As illustrated in FIG. 9, the batteries 120 may also be optionally supplemented with external batteries 121 (of a similar or different battery technology). With reference to FIG. 1D, another exemplary hybrid generator embodiment 100 replaces the conventional engine assembly 102 (e.g., a diesel engine) with an exemplary gas turbine.

The motor controller 118 is a bidirectional device. Thus, when the batteries 120 are being charged, power is passing through the motor controller 118 and towards the batteries 120. When the batteries 120 are outputting power to the electric motor 108, power is passing through the motor controller 118 in the other direction and towards the electric motor 108. When the batteries 120 have been fully (or sufficiently) charged (with reference to a charge threshold or other criteria for determining a charge state of the batteries 108), the hybrid generator 100 (e.g., controller 101) disengages (opens) the clutch 108 and shuts down the engine 102. When the battery 108 is nearly depleted (e.g., to a charge level at or below 10%) or if a significantly high load (e.g., load 130) is detected, the controller 101 of the hybrid generator 100 turns on the engine 102 and engages the clutch 106. While the engine 102 is running, the engine 102 is supporting the load (e.g., load 130) and also rotating the electric motor 108 to charge the batteries 120 (with the power output from the electric motor 108, via the motor controller 118). If there is a sudden very high load such as motor starting (e.g., higher than what the engine 102 alone can handle), the controller 101 can direct the motor controller 118 to stop charging the batteries 120 and start running the engine 102 in parallel with the electric motor 108 to power the unusually high load (See FIG. 12C). That is, if there is a sufficient charge in the battery 120, both the engine 102 and the electric motor 108 (with the batteries 120 powering the electric motor 108 via the motor controller 118) can be used in parallel to rotate the alternator 110 together and supply the load demanded (e.g., load 130).

As discussed herein, the operations of the hybrid generator 100 (e.g., engaging/disengaging the clutching mechanism 106, starting/stopping the engine 102, and outputting power to the electric motor 108 or recharging the battery 120) are controlled by a controller 101. While a plurality of batteries 120 are illustrated, it is understood that one or more batteries of the same or different type are anticipated. The batteries 120 may be of any desired chemistry or configuration (e.g., lead-acid batteries, lithium-titanium-oxide (LTO) batteries, lithium-ion batteries, nickel-cadmium (Ni-Cd) batteries, sodium-ion batteries, and nickel-metal hydride (Ni-MH) batteries. In addition, supercapacitors may be used as an alternative to batteries.

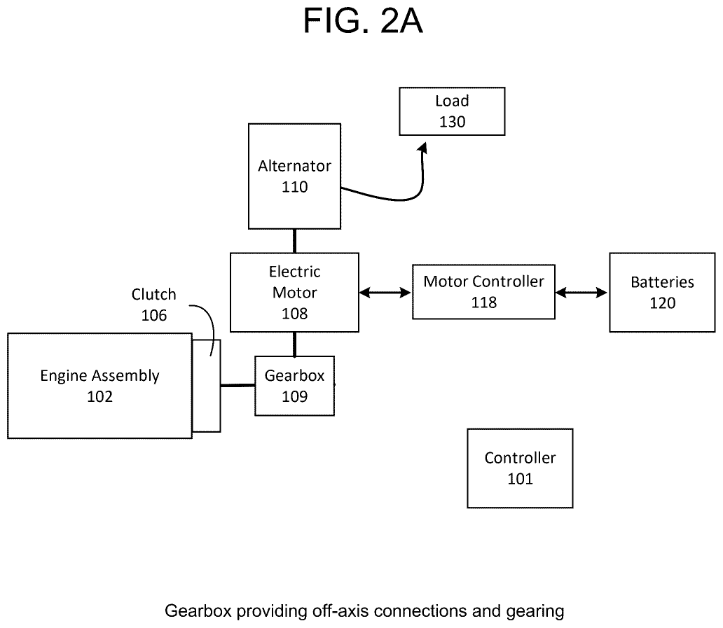

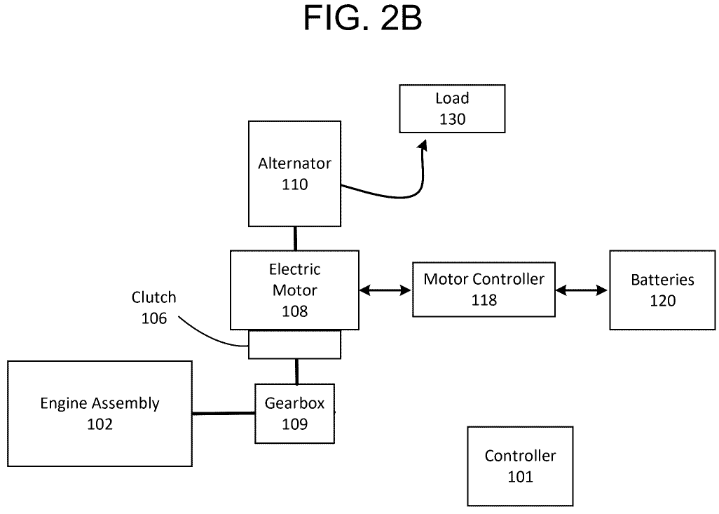

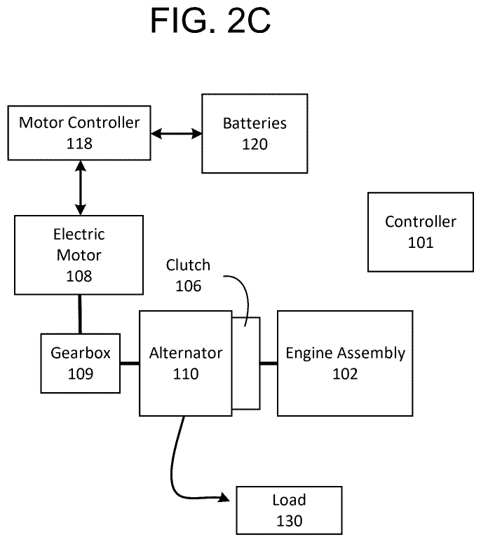

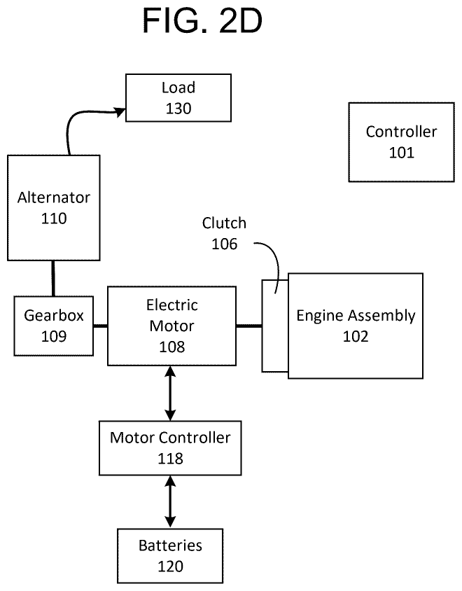

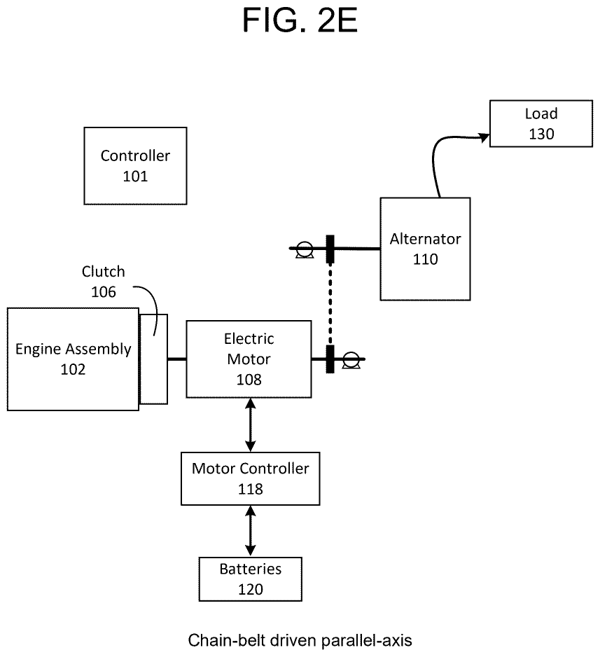

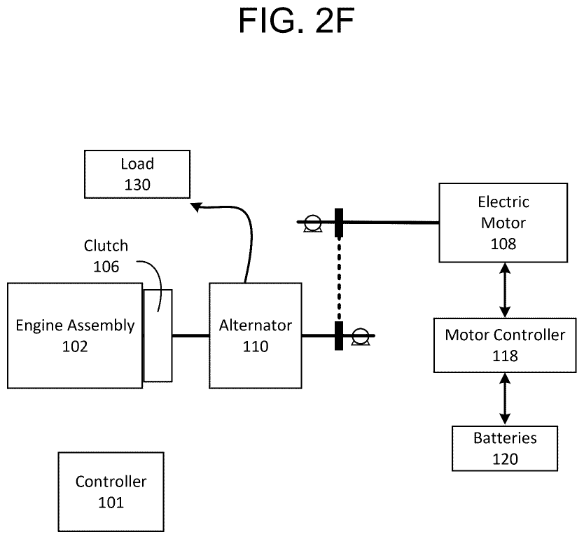

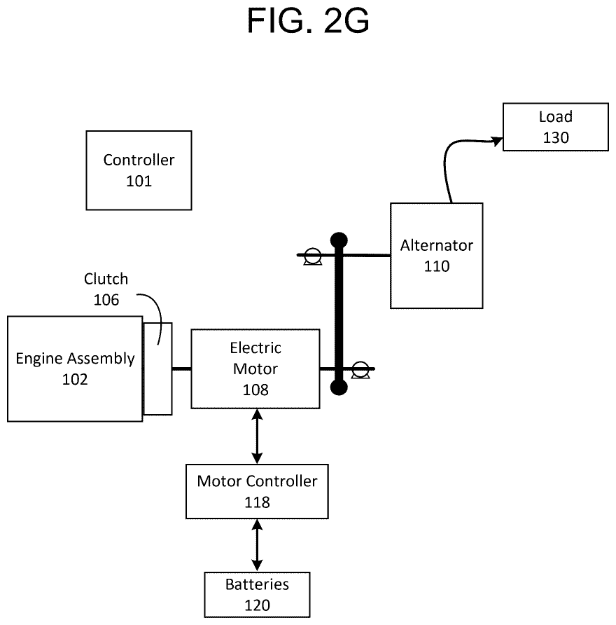

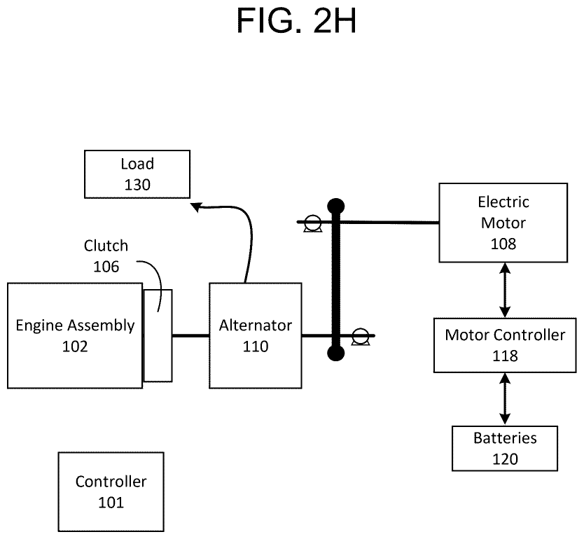

As illustrated in FIGS. 1A and 1B, the electric motor 108 can be physically in-line with the alternator 110 and the engine 102. In an alternative embodiment, a chain or belt drive could be used, which would cause either the alternator 110 or the electric motor 108 to be physically offset to the engine's crank shaft (see FIGS. 2E-2H)

As discussed herein, the hybrid generator 100 may operate in multiple (e.g., five) different modes. In an exemplary first mode illustrated in FIG. 12B, referred to as a “charging mode” of the hybrid generator 100, the batteries 120 are charged. In the charging mode, the controller 101 will turn on the engine 102 (if previously off) and engage (close) the clutching mechanism 106. In the charging mode, the engine 102 is providing all of the power to rotate the electric motor 108 and the alternator 110. In the charging mode, the electric motor 108 is charging the batteries 120 through the motor controller 118. In one embodiment, the controller 101 will begin the charging mode (when transitioning from the discharging mode to the charging mode) by turning on the engine 102. Once the rotational speed (RPM) of the engine 102 matches the rotational speed (RPM) of the electric motor 108. Once the engine's rotational speed (RPM) matches the rotational speed (RPM) of the electric motor 108, the controller 101 will engage (close) the clutching mechanism 106 and command the motor controller 118 to enter a battery charging mode.

In an exemplary second mode illustrated in FIG. 12A, referred to as a “discharging mode” of the hybrid generator 100, power from the batteries 120 are used to power the electric motor 108 to rotate the alternator 110 and provide power to the load 130. In the discharging mode, the controller 101 will turn the engine 102 off and disengage (open) the clutching mechanism 106, such that the electric motor 108 rotates the alternator 110 using power provided by the batteries 120 through the motor controller 118. In one embodiment, the controller 101 will begin the discharging mode (when transitioning from the charging mode to the discharging mode) by providing power to the electric motor 108 such that the electric motor 108 begins to rotate. Once the electric motor 108 is rotating at or above a selected RPM, the controller 101 will disengage (open) the clutching mechanism 106 and turn the engine 102 off. In another embodiment, the controller will disengage (open) the clutching mechanism 106 and turn off the engine 102 once the electric motor 108 is rotating at a selected RPM that exceeds the rotational speed of the engine 102 by a selected amount. In yet another embodiment, the controller will disengage (open) the clutching mechanism 106 and turn off the engine 102 once the electric motor 108 is rotating at an RPM sufficient for the electric motor's power output to match or exceed the engine's power output. Once the clutching mechanism 106 has been disengaged (open), the controller 101 will select a rotational rate (RPM) for the electric motor 108 to provide a desired output frequency (from the alternator 110).

In an exemplary third mode illustrated in FIG. 12C, referred to as a “peak power mode” of the hybrid generator 100, the engine 102 and the electric motor 108 are used together to power the load 130. In the peak power mode, the controller 101, in response to an electrical load (e.g., load 130) exceeding the ability of the electric motor 108 or the engine 102 to support the load 130, the controller will select the peak power mode. In the peak power mode, as controlled by the controller 101, the clutch 106 is engaged, and the engine 102 is running, such that both the engine 102 and the electric motor 108 provide power (torque) to rotate the alternator 110 powering the load 130. In the peak power mode, the controller 101 will start the engine 102 if the engine 102 was previously turned off.

In an exemplary fourth mode illustrated in FIG. 12D, referred to as a “fault bypass mode” of the hybrid generator 100, the alternator 110 is rotated by engine power only. In the fault bypass mode, the system (e.g., via the controller 101) has detected a fault such as a component failure with any combination of the electric motor 108, motor controller 118, and batteries 120. In the fault bypass mode, as controlled by the controller 101, the clutch 106 is engaged (closed) and the engine 102 is running, such that the alternator 110 is rotated by engine power only.

In an exemplary fifth mode illustrated in FIG. 12E, referred to as an “environmental conditions bypass mode” of the hybrid generator 100, the alternator 110 is rotated by engine power only. The environmental conditions bypass mode is selected by the controller 101 due to ambient environment conditions (extreme heat or cold), such that one or more of the electric motor 108, the motor controller 118, or batteries 120 are outside of their operating temperature range(s). In one embodiment, each component of the hybrid generator 100 has an operational range defined by a corresponding high temperature threshold and low temperature threshold. In the environmental conditions bypass mode, the clutch 106 is engaged, the engine 102 is running, and the alternator 110 is rotated by engine power only. In the environmental conditions bypass mode, when operating in extreme cold, heat transfer from the operation of the engine 102 will eventually bring the temperatures of the components (of the hybrid generator 100) into their operational ranges. Likewise, when operating in extreme heat, falling ambient temperatures and heat transfer out of the components (of the hybrid generator 100) will eventually bring the temperatures of the components into their operational range(s). That is, the ambient temperature and the operational conditions of the hybrid generator 100 will affect the temperatures of the components (e.g., engine 102, electric motor 108, alternator 110, motor controller 118, and batteries 120) of the hybrid generator 100.

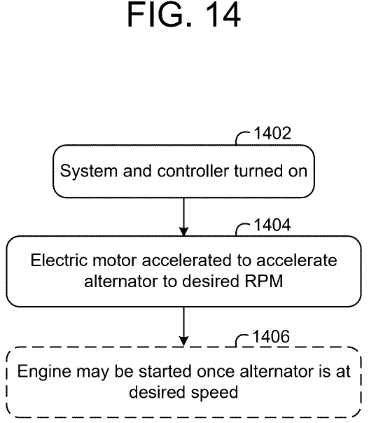

FIG. 14 is a flow diagram illustrating steps to an exemplary normal startup procedure, while operating in normal conditions (no faults, and all components are in their normal operating range), in one exemplary embodiment, the following steps will be carried out.

In step 1402, a first step of the normal startup procedure, the system 100 and controller 101 will be turned “on.” By default, the clutch 106 is disengaged (open). Thus, with no power, the clutch 106 should be “normally open.”

In step 1404, a second step of the normal startup procedure, the electric motor 108 will be quickly accelerated such that the coupled alternator 110 will be quickly accelerated up to the desired speed (RPM).

In step 1406, an optional third step of the normal startup procedure, the engine 102 may be started once the alternator 110 is at the desired speed. For example, this may be done if the battery 120 is at a low state of charge (but not over-discharged) such that the expected engine runtime to bring the battery 120 to a full state of charge is equal to or greater than 30 minutes.

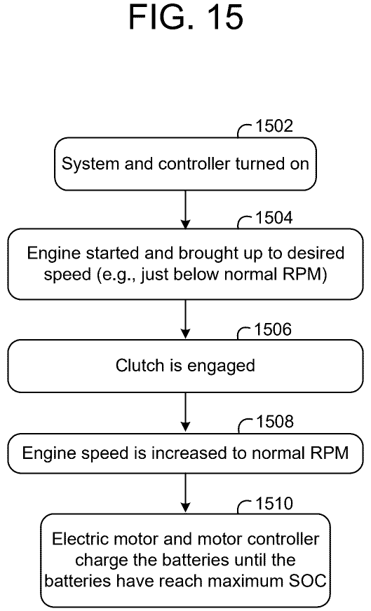

FIG. 15 is a flow diagram illustrating steps to an exemplary alternative to the normal startup procedure (an “alternative startup procedure”), when the batteries 120 are in an over-discharged state, in one exemplary embodiment, the following steps will be carried out.

In step 1502, a first step of the alternative startup procedure, the system 100 and controller 101 will be turned “on.” By default, the clutch 106 is disengaged (open). Thus, with no power, the clutch 106 should be “normally open.”

In step 1504, a second step of the alternative startup procedure, the engine 102 will be started and brought up to a speed less than the normal operating RPM, for example, 1500 RPM.

In step 1506, a third step of the alternative startup procedure, the clutch 106 will be engaged.

In step 1508, a fourth step of the alternative startup procedure, the engine speed will quickly increased to the normal operating speed.

In step 1510, a fifth step of the alternative startup procedure, the electric motor 108 and the motor controller 118 charge the batteries 120 until the batteries 120 have reached a maximum state of charge.

As discussed herein, any suitable electric motor 108 can be used. In one embodiment, a right-angle AC or DC motor (e.g., electric motor 108) is used in the hybrid generator 100. Other electric motor configurations are also anticipated, such as an exemplary axial flux motor (pancake motor).

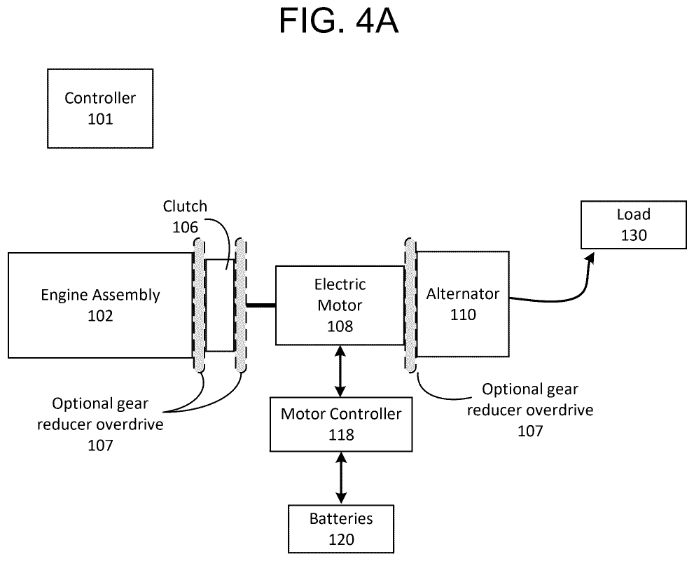

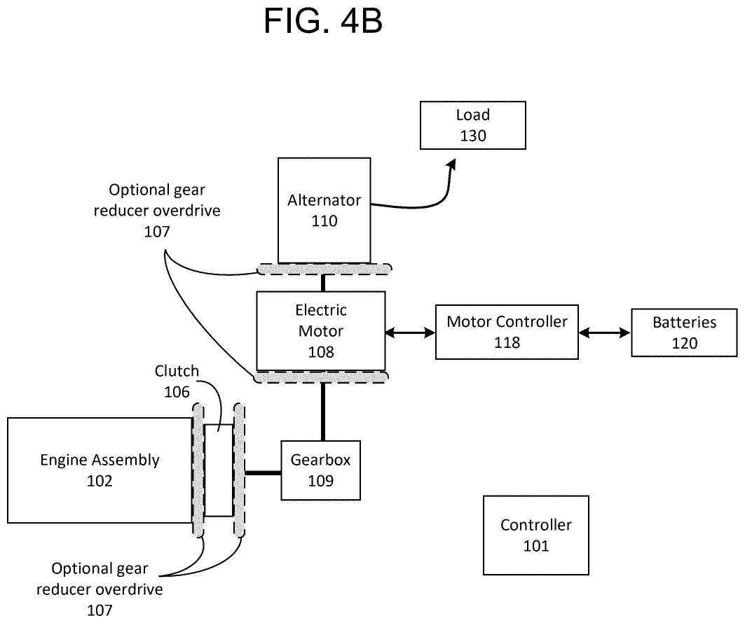

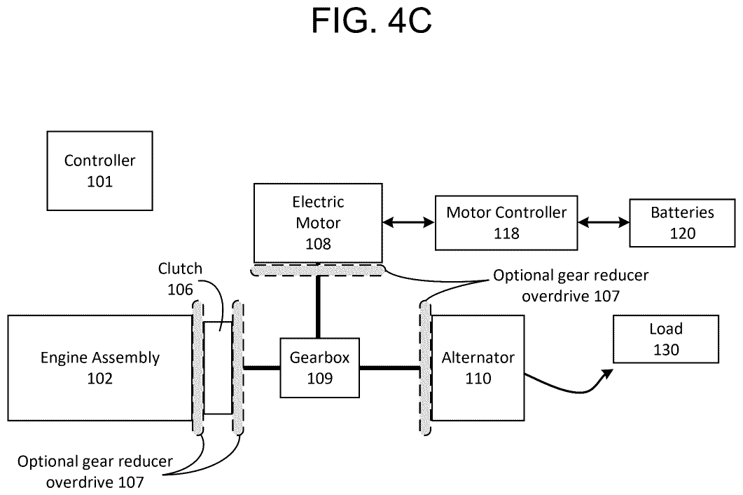

Referring to FIGS. 2A-2E, 3, and 4A-4C, in an alternative hybrid generator 100, the engine 102, alternator 110, electric motor 108, and clutch mechanism 106 can be off-axis to each other via right-angle components or an off-axis belt/chain or a right-angle gear driven electric motor 108. For example, with reference to FIGS. 2A-2H, the hybrid generator 100 includes a right-angle electric motor 108 or a gearbox 109 positioned between the engine 102 and the electric motor 108. As discussed herein, the gearbox 109 can be coupled to the engine 102 via a gear reducer or gear overdrive 107 (see FIGS. 4A, 4B, and 4C). These alternative embodiments of the hybrid generator 100 provide for a variety of different component configurations/arrangements. For example, in FIG. 6B, the inertial storage flywheel 104 is coupled to the clutch 106, which is coupled to the electric motor 108. As discussed herein, in other embodiments, a gear reducer or gear overdrive 107 and/or gearbox 109 may also be used. Referring to FIG. 2A, the alternator 110 is in-line with the electric motor 108, which is coupled to the gearbox 109. FIGS. 2A and 2B illustrate an alternative placement of the clutching mechanism 106. In FIG. 2A, the clutch 106 is coupled to the engine 102, while in FIG. 2B, the clutch 106 is illustrated coupled to the electric motor 108. The embodiment illustrated in FIG. 2C features the engine 102 in line with the alternator 110, while the electric motor 108 (via the gear box 109) is orthogonal to the direction of the engine 102 and alternator 110. With the use of one or more gear reducer or gear overdrives 107, an optimization of motor 108 and/or engine 102 RPM efficiency is possible (see FIGS. 4A, 4B, and 4C). For example, gearing coupled between the motor 108 and the alternator 108 ensures the RPM of the alternator 108 provides the required frequency desired (e.g., 50/60/400 Hz).

FIGS. 2A-2D illustrate further exemplary embodiments of the hybrid generator 100. In FIG. 2A, a single input, single output gearbox 109 is coupled between the engine 102 and the electric motor 108, and with the alternator 110 mechanically coupled to the opposite side of the electric motor 108 such that both the electrical motor 108 and alternator 110 are arranged in line and orthogonal to the engine 102. FIGS. 2B-2D illustrate additional alternative embodiments using a single input, single output gearbox. Referring to FIG. 2B, as compared to the embodiment illustrated in FIG. 2A, the clutching mechanism 106 is arranged next to the electric motor 108 (rather than next to the engine assembly 102, as illustrated in FIG. 2A). Referring to FIG. 2C, the alternator 110 and engine assembly 102 are coupled together in-line such that the alternator couples to the gearbox 109. The electric motor 108 is illustrated coupled on another side of the gearbox 109 such that the electric motor 108 is orthogonal to the engine 102 (and alternator 110). Note that a clutch 106 is illustrated coupled to the alternator 110 (on the side facing the engine assembly 102). Referring to FIG. 2D, the electric motor 108 and engine assembly 102 are coupled together in-line such that the electric motor 108 couples to the gearbox 109. The alternator 110 is illustrated coupled on another side of the gearbox such that the alternator 110 is orthogonal to the engine 102 (and electric motor 108). Note that a clutch 106 is illustrated coupled to the engine assembly 102 (between the engine assembly 102 and the electric motor 108).

Referring to FIGS. 2E-2H, in further alternative embodiments of the hybrid generator 100, the electric motor 108 may be coupled to the alternator 110 via a chain or belt drive. As illustrated in FIGS. 2E-2H, the use of the chain or belt drive causes the alternator 110 or the electric motor 108 to be physically offset to the engine's crank shaft. In FIG. 2E, the electric motor 108 is in-line with the engine 102, while the alternator 110 is coupled to the electric motor 108 via a chain drive such that the alternator 110 is physically offset to the engine's crank shaft. In FIG. 2F, the alternator 110 is in-line with the engine 102, while the electric motor 108 is coupled to the alternator 110 via a chain drive such that the electric motor 108 is physically offset to the engine's crank shaft. In FIG. 2G, similar to FIG. 2E, the electric motor 108 is in-line with the engine, while the alternator 110 is coupled to the electric motor 108 via a belt drive such that the alternator is physically offset to the engine's crank shaft. In FIG. 2H, similar to FIG. 2F, the alternator 110 is in-line with the engine 102, while the electric motor 108 is coupled to the alternator 110 via a belt drive such that the electric motor is physically offset to the engine's crank shaft.

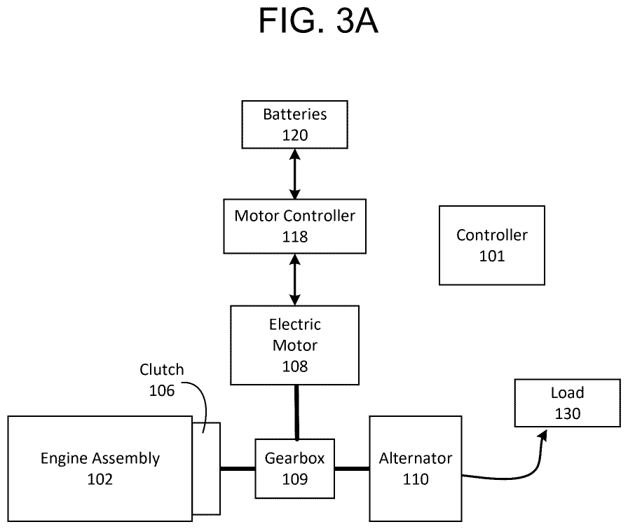

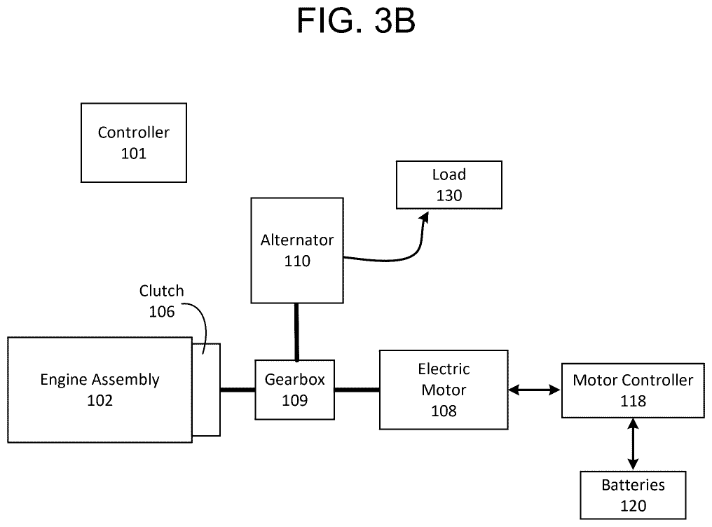

FIG. 3A illustrates a further embodiment of the hybrid generator 100. In FIG. 3A, a single input, dual output gearbox 109 is coupled between the engine 102 and the electric motor 108 and the alternator 110. As illustrated in FIG. 3A, the alternator 110 is coupled to the opposite side of the gearbox 109 with respect to the engine 102 such that the engine 102 and the alternator 110 are arranged in line, while the electric motor 108 is orthogonal to the engine 102.

FIG. 3B illustrates a further embodiment of the hybrid generator 100. In FIG. 3B, a single input, dual output gearbox 109 is coupled between the engine 102 and the electric motor 108 such that the engine 102 and the electric motor 108 are arranged in-line, while the alternator 110 is orthogonal to the engine 102.

FIGS. 4A-4C illustrate further embodiments of the hybrid generator 100. FIG. 4A illustrates an optional placement of gear reducer/overdrives 107 in an axial configuration of the engine assembly 102, electric motor 108, and alternator 110. FIG. 4B illustrates an optional placement of gear reducer/overdrives 107 in a configuration that incorporates a single input single output gearbox 109 (with the alternator 110 and electric motor 108 arranged in-line together and orthogonal to the engine assembly 102). FIG. 4C illustrates another optional placement of gear reducer/overdrives 107 in a configuration that incorporates a single output dual output gearbox 109. As illustrated in FIG. 4C, the engine assembly 102 and alternator 110 are arranged on opposite sides of the gearbox 109 while the electric motor 108 is arranged on another side of the gearbox 109 such that the electric motor is orthogonal to the engine assembly 102 (and alternator 110).

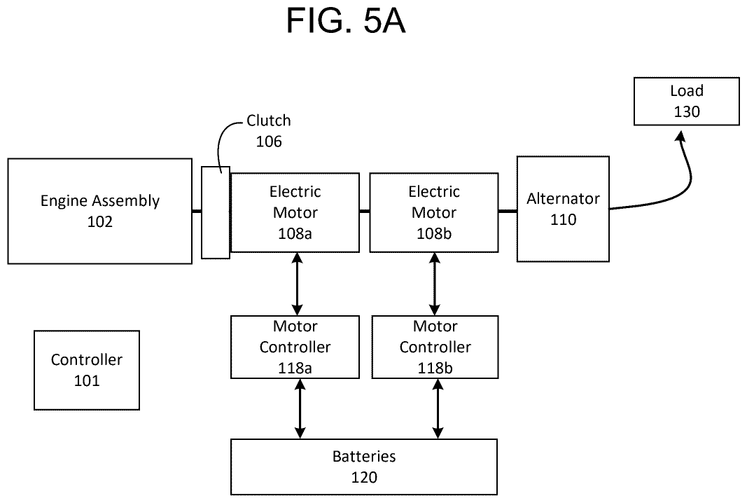

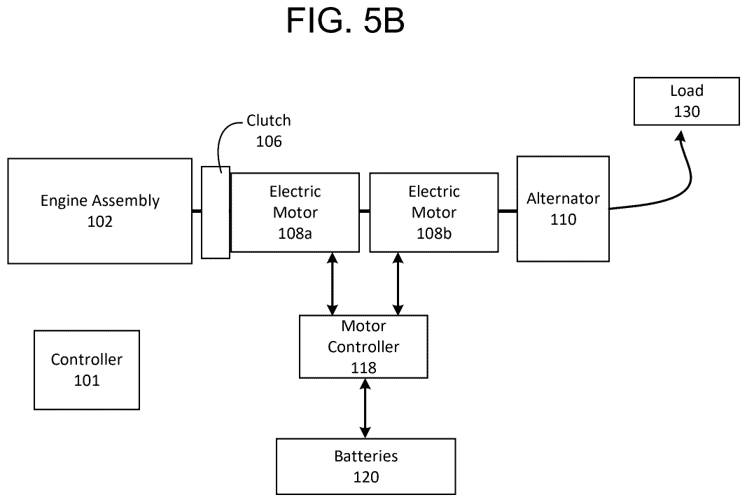

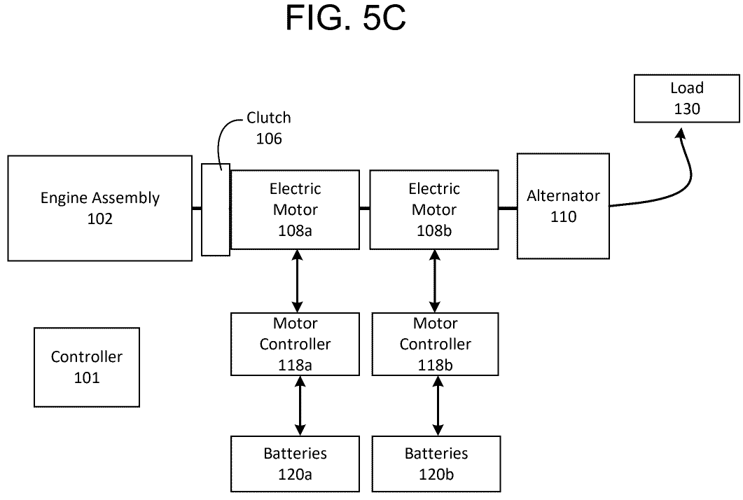

FIGS. 5A-5C illustrate further alternative embodiments that incorporate multiple electric motors 108, motor controllers 118, and batteries 120. FIG. 5A illustrates two or more electric motors (e.g., electric motors 108a, 108b) each with a dedicated motor controller (e.g., motor controllers 118a, 118b), with the motor controllers 118a, 118b sharing the same batteries 120. FIG. 5B illustrates multiple electric motors (e.g., electric motors 108a, 108b) sharing a common motor controller 118 and common batteries 120. FIG. 5C illustrates two or more electric motors (e.g., electric motors 108a, 108b), each coupled to a respective dedicated motor controller (e.g., motor controllers 118a, 118b) and a respective dedicated battery (e.g., batteries 120a, 120b).

FIGS. 6A-6C illustrate further alternative embodiments that incorporate an inertial energy storage flywheel. FIG. 6A illustrates an embodiment that incorporates an inertial storage flywheel 104 positioned between the alternator 110 and the electric motor 108. FIG. 6B illustrates an embodiment that incorporates an inertial storage flywheel 104 positioned between the engine assembly 102 and the electric motor 108. FIG. 6C illustrates an embodiment that incorporates an inertial storage flywheel 104 positioned adjacent to the alternator 110.

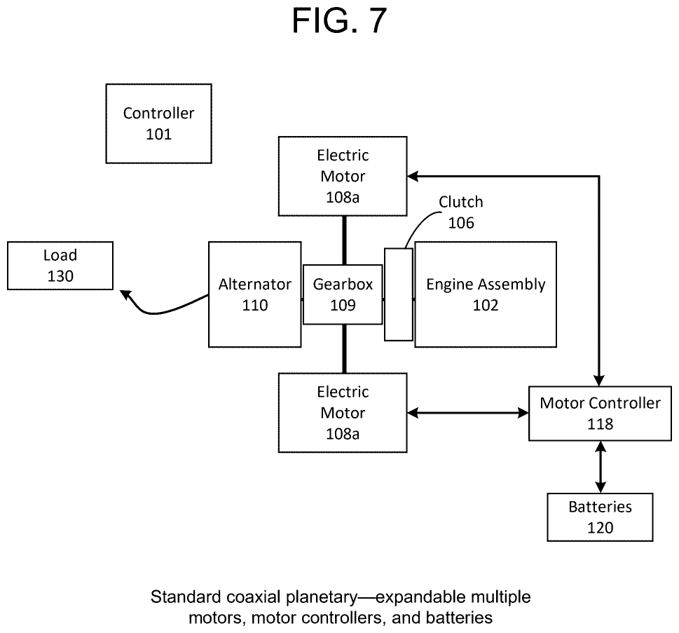

FIG. 7 illustrates a further embodiment that incorporates multiple electric motors (e.g., electric motors 108a, 108b) integrated into a planetary gearbox 109.

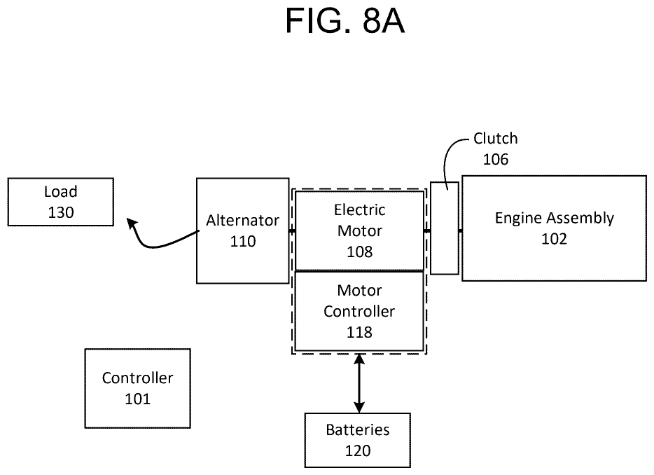

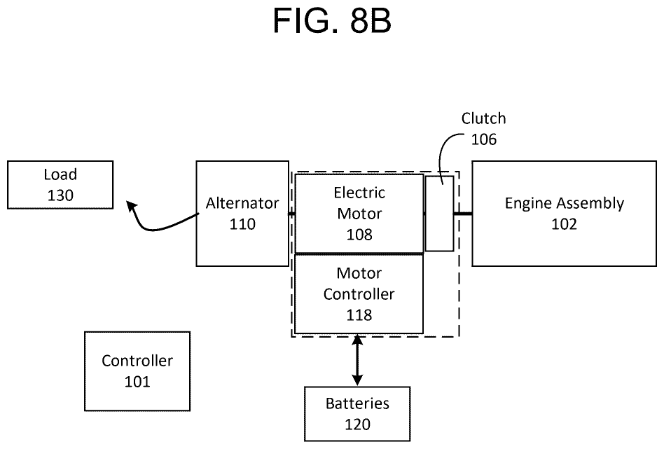

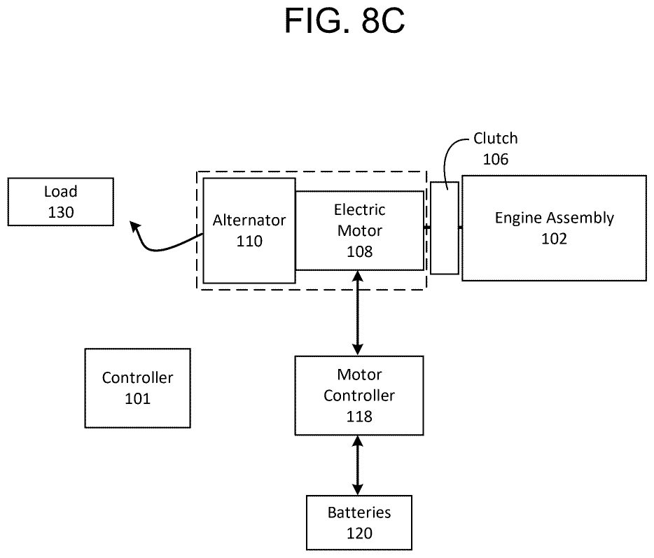

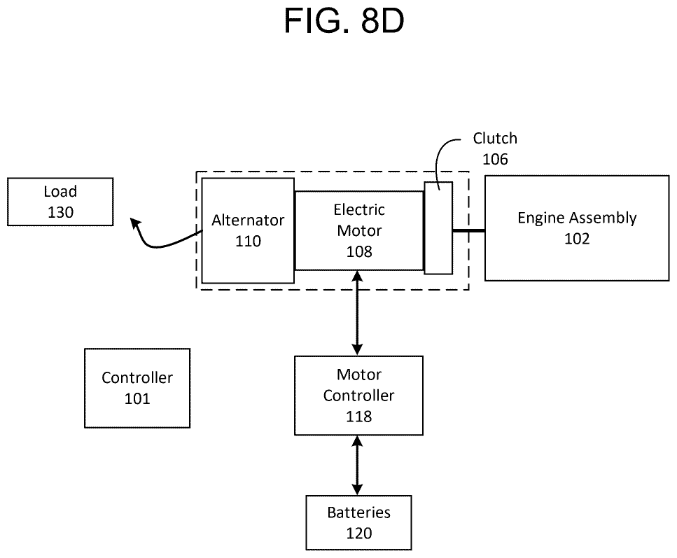

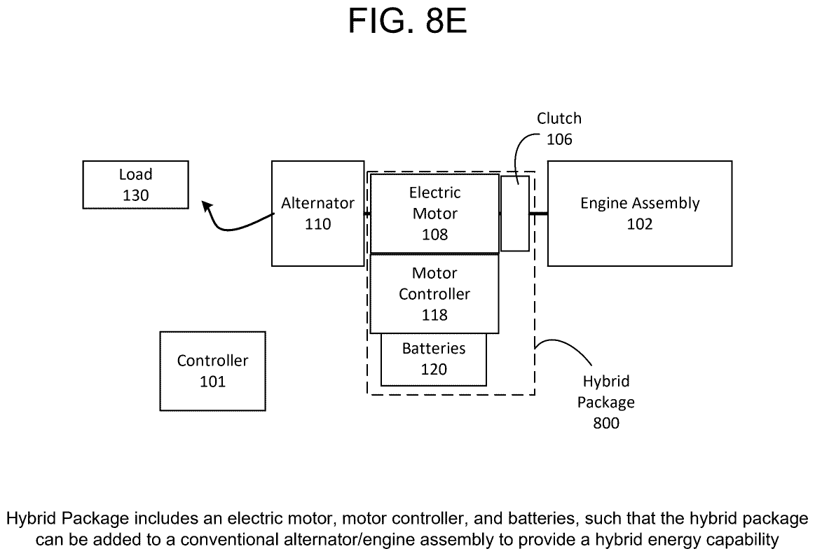

FIGS. 8A-8E illustrate further embodiments that incorporate alternative packaging for the alternator 110, the electric motor 108, the motor controller 118 and the clutching mechanism 106. FIG. 8A illustrates the electric motor 108 and motor controller 118 in a single assembly. FIG. 8B illustrates the electric motor 108, the motor controller 118, and the clutching mechanism 106 in a single assembly. FIG. 8C illustrates the alternator 110 and the electric motor 108 in a single assembly. FIG. 8D illustrates the alternator 110, the electric motor 108, and the clutching mechanism 106 in a single assembly. The exemplary embodiments illustrated in FIGS. 8A-8E may be integrated into a hybrid generator 100 in any desired configuration or arrangement, such as illustrated in any of the exemplary embodiments described herein.

FIG. 8E illustrates an exemplary “hybrid package” comprising an electric motor 108, a motor controller 118, and batteries 120 in a single assembly 800. In one exemplary embodiment, the hybrid assembly 800 provides for the addition of a hybrid package to be added to a conventional alternator/engine assembly to realize an exemplary hybrid generator. As illustrated in FIG. 8E, by placing the hybrid assembly 800 between the alternator 110 and the engine assembly 102, a conventional genset can be converted into a hybrid generator. In one embodiment, the components of the hybrid assembly 800 are integrated into a single housing which is arranged with respect to the alternator 110 and the engine assembly 102. In another embodiment, the components of the hybrid assembly 800 are arranged in two or more housings that are arranged with respect to the alternator 110 and the engine assembly 102.

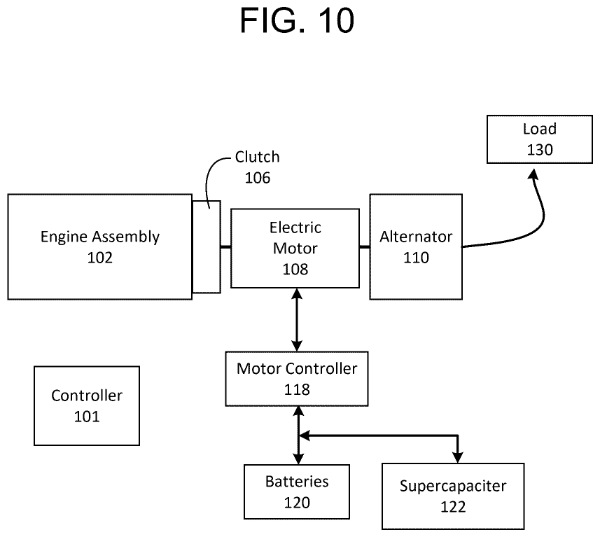

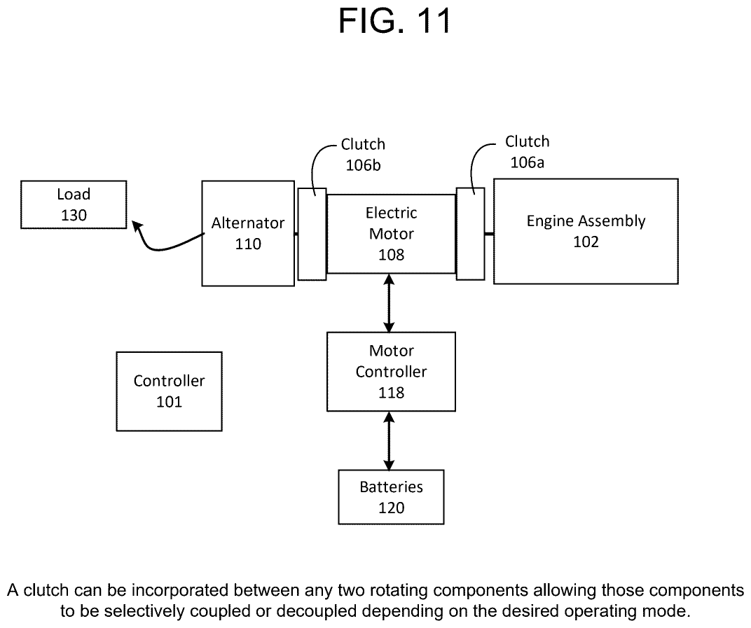

FIGS. 9-11 illustrate further exemplary embodiments of the hybrid generator 100. As illustrated in FIG. 9, in one embodiment, the motor controller 118 is coupled to both the batteries 120 and external batteries 121. In FIG. 10, the motor controller 118 is coupled to both the batteries 120 and a supercapacitor 122. While FIGS. 9 and 10 illustrate external batteries 121 or a supercapacitor 122 coupled to the motor controller 118 (along with the batteries 120), in other exemplary embodiments, the batteries 120 may be replaced by the supercapacitor 122. Alternatively, the batteries 120 may incorporate the supercapacitor 122. In a further alternative, the external batteries 121 may incorporate the supercapacitor 122. FIG. 11 illustrates a further alternative embodiment that illustrates the alternative placement of clutches (e.g., clutching mechanisms 106a, 106b) between the alternator 110 and the electric motor 108, and between the electric motor 108 and the engine assembly 102, respectively. Thus, as illustrated in FIG. 11, a clutch 106 can be incorporated between any two rotating components allowing those components to be selectively coupled or decoupled depending on the desired operating mode of the hybrid generator 100.

Accordingly, as described herein, the components of an exemplary hybrid generator embodiment 100 may therefore be configured or arranged in a variety of different configurations. For example, as illustrated in FIGS. 1A and 1B, the engine assembly 102, alternator 110, and electric motor 108 may be arranged in any order and in a variety of different packaging configurations (see FIGS. 8A-8E). As discussed herein, the components may be arranged in-line or in an off-axis or orthogonal position with respect to each other (see FIGS. 1A and 1B). As illustrated in FIGS. 2A-2D, 3A, 3B, 4B, 4C, and 7, the hybrid generator 100 may also include a gearbox 109 such that one or more of the components can be arranged orthogonally with respect to one or more other components of the hybrid generator 100. As illustrated in FIGS. 2A and 2B (as well as discussed herein), the hybrid generator 100 may be configured with one or more clutch mechanism 106 in different positions (e.g., coupled to the engine assembly 102, the electric motor 108, and/or the alternator 110). As illustrated in FIGS. 2E-2H, the hybrid generator 100 may also be configured with a chain or belt drive, such that, for example, either the alternator 110 or the electric motor 108 could be physically offset, yet parallel to the engine's crank shaft. As illustrated in FIGS. 4A-4C and 6A-6C, the hybrid generator 100 may also be configured with one or more gear reducer/overdrives 107 and/or a flywheel 104. As also discussed herein, while many of the embodiments discussed herein include only a single electric motor 108, motor controller 118, and set of batteries 120, it is understood that exemplary hybrid generator embodiments 100 may include one or more of each (see FIGS. 5A-5C).

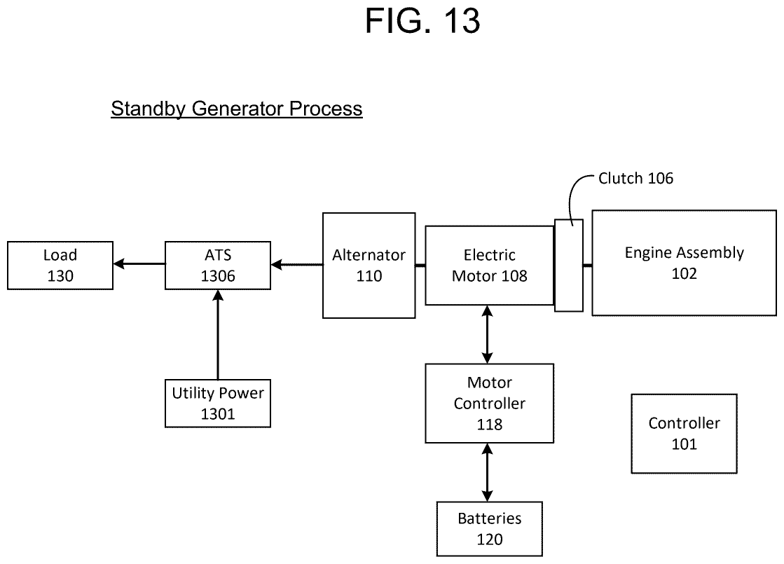

Referring to FIG. 13, in one hybrid generator embodiment 100, an exemplary automatic transfer switch (ATS) 1306 is configured to selectively couple a utility power supply (e.g., utility power 1301) or a power output from the alternator 110 of the hybrid generator 100 configured to operate as a standby or backup generator. The ATS 1306 continuously monitors the output from the utility power supply 1301. In one embodiment, the ATS 1306 monitors all three phases of a three-phase voltage output, and the frequency of the voltage output. When the hybrid generator 100 is configured as a standby generator, the clutch 106 would be normally open and disconnecting the engine 102 from the driveline (the electric motor 108 and the alternator 110). Upon a signal from the ATS 1306, the controller 101 signals the motor controller 118 to power the electric motor 108. As discussed herein, in a startup mode, the electric motor 108 and alternator 110 reach a desired rotational speed for a desired frequency output (e.g., 1800 RPM for 60 Hz). In one embodiment, the electric motor 108 and alternator 110 reach the desired RPM in under five (5) seconds. Upon the voltage level and frequency of the voltage output from the alternator 110 stabilizing, the ATS 1306 opens the electrical contacts to the utility power supply 1301 and the load 130 is disconnected from the utility power supply. The ATS 1306 also closes the electrical contacts to the alternator 110 and the alternator 110 begins powering the load 130. As also discussed herein, while the output of the alternator 110 is being powered by the rotational torque of the electric motor 108, the engine 102 is also being started by the controller 101. The engine 102, after warming up, proceeds to reach a target rotational rate (e.g., an exemplary 1800 RPM for a stable 60 Hz and voltage). When the engine output is fully stable, the clutch 106 will engage making the rotational torque from the electric motor 108 and the engine 102 available to rotate the alternator 110 and power the load 130. Depending on load demand and a charge state of the batteries 120, a seamless standby generator operation can be realized. Thus, as described herein, the hybrid generator 100, when operating in a standby generator mode, is operable to provide a mode where only the electric motor 108 is rotating the alternator 110. In another mode, the engine 102 and electric motor 108 are both rotating the alternator 110 for a peak demand situation. Lastly, in a charging mode, the engine 102 will be rotating the alternator 110 by itself (to power the load 130) and rotating the electric motor 108 to recharge the batteries 120 (via the motor controller 118).

Thus, an exemplary hybrid generator embodiment 100 may be configured in a variety of different configurations incorporating an engine assembly, an electric motor (with associated motor controller and batteries), and alternator. As discussed herein, the engine assembly, electric motor, and alternator can be arranged in an axial configuration, or arranged with one or more of them off-axis or orthogonal with respect to the other(s). Regardless of the arrangement between the engine assembly, electric motor, and alternator, when the engine assembly is running, the electric motor will be rotated, and a voltage output is produced to charge the battery (via the bidirectional motor controller). When the engine assembly is running and rotating the electric motor, the alternator will also be rotating producing a power output for a load. When the battery is fully charged, the engine assembly can be turned off and decoupled from the electric motor and alternator when a clutching mechanism between the engine and the electric motor and alternator is disengaged. One or more clutching mechanisms may be utilized. With the engine assembly turned off and the clutching mechanism disengaged, the battery can be used to power the electric motor, which would be used to rotate the alternator (and continue powering the load). The electric motor can be used to rotate the alternator to power the load until the battery's charge reaches a low power threshold. When that happens, the engine assembly is restarted, its rotational speed is matched to the electric motor and the clutching mechanism is re-engaged. With the engine assembly running and the clutching mechanism engaged, the electric motor (rotated by the engine assembly) will begin recharging the battery. Thus, the alternator will be rotated to produce power to a load by either the engine assembly or the electric motor.

1. A hybrid generator configured to power an external electrical load, wherein the hybrid generator comprises:
an engine assembly, an electric motor, and an alternator;
a generator controller and a motor controller;
a battery;
a clutching mechanism arranged between the engine assembly and the electric motor and the alternator;
wherein the alternator is configured to output power to a connector for the external electrical load;
wherein the motor controller is a bi-directional device configured to power the electric motor from the battery or to charge the battery from the electric motor;
wherein when the clutching mechanism is engaged, the engine assembly is configured to rotate the electric motor and alternator together and to power the external electrical load via a power output from the alternator, and further configured to charge the battery through the motor controller;
wherein when the clutching mechanism is disengaged, the electric motor is configured to rotate the alternator to power the external electrical load via the power output from the alternator, wherein the electric motor is configured to rotate the alternator as controlled by the motor controller; and
wherein the generator controller is configured to control at least one of the engine assembly, the clutching mechanism, the motor controller, and the electrical motor, wherein the generator controller is configured to selectively keep the alternator rotating selectively using at least one of the engine assembly and the electric motor, and wherein the generator controller is configured to operate in a charge mode when the engine assembly is running and a discharge mode when the engine is not running.

2. The hybrid generator of claim 1, wherein the engine assembly is mechanically coupled to the clutching mechanism.

3. The hybrid generator of claim 2, wherein the clutching mechanism is also mechanically coupled to either the electric motor or the alternator.

4. The hybrid generator of claim 1, wherein the clutching mechanism is electrically controlled, wherein the generator controller is configured to, while operating in the charge mode, when the battery is at a maximum state of charge, to transition to the discharge mode, wherein the generator controller is configured to transition to the discharge mode by adjusting the speed of the electric motor to a selected rotational speed that exceeds the rotational speed of the engine assembly by a selected amount, and wherein once an output power of the electric motor matches the engine assembly output power, the generator controller is configured to disengage the clutching mechanism, shut down the engine using a shutdown cycle, and select a rotational speed of the electric motor to provide a desired output frequency.

5. The hybrid generator of claim 1, wherein the clutching mechanism is electrically controlled, wherein the generator controller is configured to, while operating in the discharge mode, when the battery is at a minimum state of charge, to transition to the charge mode, wherein the generator controller is configured to transition to the charge mode by starting the engine assembly and adjusting a rotational speed of the engine to match that of the electric motor, and wherein once the rotational speed of the engine assembly matches the rotational speed of the electric motor, the generator controller is configured to engage the clutching mechanism and command the motor controller to enter a battery charging mode.

6. The hybrid generator of claim 1, wherein the clutching mechanism is mechanically actuated, wherein the generator controller is configured to, while operating in the charge mode, when the battery is at a maximum state of charge, to transition to the discharge mode, wherein the generator controller is configured to transition to the discharge mode by incrementally reducing the rotational speed of the engine assembly until an output power of the electric motor matches the output power of the engine assembly, and wherein once the output power of the electric motor matches the output power of the engine assembly, the generator controller is configured to turn off the engine assembly.

7. The hybrid generator of claim 1, wherein the clutching mechanism is mechanically actuated, wherein the generator controller is configured to, while operating in the discharge mode, when the battery is at a minimum state of charge, to transition to the charge mode, wherein the generator controller is configured to transition to the charge mode by starting the engine assembly and adjusting a rotational speed of the engine to a selected percentage of the rotational speed of the electric motor, and wherein once the rotational speed of the engine assembly causes the power output of the electric motor to approach a zero power output, the generator controller is configured to command the motor controller to enter a battery charging mode.

8. The hybrid generator of claim 1, wherein the engine assembly is coupled to the electrical motor and the alternator via a single output shaft 90-degree gearbox, wherein the clutching mechanism is mounted between one of:
the engine assembly and the gearbox;
the gearbox and the electric motor and alternator;
the engine assembly and the alternator, and wherein the gearbox is positioned between the alternator and the electric motor; and
the engine assembly and the electric motor, and wherein the gearbox is positioned between the electric motor and the alternator.

9. The hybrid generator of claim 1, wherein the engine assembly is coupled to the input shaft of a dual output 90-degree gearbox via the clutching mechanism, wherein a first output shaft of the gearbox is configured to couple the electric motor, via the clutching mechanism, to the engine assembly and alternator, wherein a second output shaft of the gearbox is configured to couple the alternator, via the clutching mechanism, to the engine assembly and the electric motor, wherein at least one of the electric motor and the alternator is mounted orthogonally to the engine assembly.

10. The hybrid generator of claim 1 further comprising one or more gear reducer/overdrives configured to allow the engine assembly, the electric motor, and the alternator to operate at different rotational speeds, wherein the one or more gear reducer/overdrives are integrated within an axial engine assembly, wherein ones of the one or more gear reducer/overdrives are mounted between at least one of the engine assembly and the clutching mechanism, between the clutching mechanism and the electric motor, and between the electric motor and the alternator, wherein when the one or more gear reducer/overdrives are integrated with a single output 90-degree gearbox, ones of the one or more gear reducer/overdrives are mounted between at least one of the clutching mechanism and the single output gearbox, and between the single output gearbox and the electric motor, and wherein when the one or more gear reducer/overdrives are integrated with a dual output 90-degree gearbox, ones of the one or more gear reducer/overdrives are mounted between at least one of clutch and the dual output gearbox, between the dual output gearbox and the electric motor, and between the dual output gearbox and the alternator.

11. The hybrid generator of claim 1, wherein the electric motor comprises a plurality of electric motors, wherein each of the plurality of electric motors is controlled by one of a plurality of corresponding motor controllers or a multi-channel motor controller, wherein each of the plurality of electric motors is coupled to either their respective motor controller of the plurality of corresponding motor controllers or via respective single input/output channels to the multi-channel motor controller, wherein the plurality of motor controllers are coupled to either a common battery or to one of a plurality of corresponding batteries.

12. The hybrid generator of claim 1 further comprising an external inertial flywheel configured to provide additional rotational inertia and energy storage for the alternator, wherein the inertial flywheel is mounted either next to the engine assembly, between the electric motor and the alternator, or opposite the engine assembly.

13. The hybrid generator of claim 1 further comprising a planetary gearbox, wherein the engine assembly is coupled to the electrical motor and the alternator via the planetary gearbox, wherein the planetary gearbox is configured to mechanically couple to the engine assembly, the alternator, and the electric motor such that at least one of the engine assembly and the electric motor can rotate the alternator, and wherein the planetary gearbox is configured to allow the engine assembly and the electric motor to both rotate the alternator with each rotating at different rotational speeds.

14. The hybrid generator of claim 1, wherein any combination of the electric motor, the alternator, the motor controller, the battery, and the clutching mechanism are integrated into a single enclosure, and further comprising a cooling system configured to cool one or more of the electric motor, the motor controller, and the alternator, and wherein the cooling system is configured as either an air cooling system or a liquid cooling system.

15. The hybrid generator of claim 1, wherein the battery is a supercapacitor and configured to perform an energy storage function, and further comprising one or more external battery packs electrically coupled to the battery, and wherein the engine assembly is configured as a gas turbine.

16. The hybrid generator of claim 1, wherein the alternator is configured to provide one or more selectable output voltages, wherein the selectable output voltages comprise 120 VAC, 240 VAC, 208 VAC, 480 VAC and 600 VAC, wherein the alternator is configured to provide one or more selectable output frequencies, and wherein the selectable output frequencies comprise 50 Hz, 60 Hz and 400 Hz.

17. The hybrid generator of claim 1, wherein the generator controller is configured to operate in a high efficiency bypass mode when it is more efficient to power the load using engine power, wherein when in the high efficiency bypass mode, the generator controller is configured to engage the clutching mechanism and to power the load using the engine assembly, and wherein the generator controller is configured to evaluate efficiency by comparing an energy efficiency of the engine assembly to a combined energy efficiency of the electric motor, motor controller, and battery.

18. The hybrid generator of claim 1, wherein the generator controller is configured to operate in a fault bypass mode when there is an operational fault in any one or more of the electric motor, the motor controller, or the battery, wherein when in the fault bypass mode, the generator controller is configured to engage the clutch mechanism and power the load using the engine assembly.

19. A hybrid generator comprising an engine assembly, a clutching mechanism, one or more electric motors, one or more batteries, one or more motor controllers, and one or more controllers;
wherein the one or more controllers are configured to implement a high efficiency bypass mode by engaging the clutching mechanism and powering a load using the engine assembly when it is more efficient to power the load using engine power; and
wherein the one or more controllers are configured to evaluate efficiency by comparing an energy efficiency of the engine assembly to a combined energy efficiency of the one or more electric motors, the one or more motor controllers, and the one or more batteries.

20. A hybrid generator comprising an engine assembly, a clutching mechanism, one or more electric motors, one or more batteries, one or more motor controllers, and one or more controllers;
wherein the one or more controllers are configured to select a fault bypass mode by engaging the clutch mechanism and powering a load using the engine assembly when there is an operational fault in any one or more of the one or more electric motors, the one or more motor controllers, or the one or more batteries, wherein the one or more controllers are configured to select the fault bypass mode when an operational fault is detected by the one or more controllers or when the one or more controllers receive an operational fault indication.

21. A hybrid generator comprising an engine assembly, a clutching mechanism, one or more electric motors, one or more batteries, one or more motor controllers, and one or more controllers;
wherein the one or more controllers are configured to select an extreme environmental conditions bypass mode when an ambient temperature causes temperatures of one or more of the one or more electric motors, the one or more batteries, or the one or more motor controllers to exceed a high temperature threshold or drop below a low temperature threshold, wherein the one or more controllers are configured to implement the selected extreme environmental conditions bypass operation mode by engaging the clutch mechanism and powering the load using only the engine assembly, wherein the one or more controllers are configured to select the extreme environmental conditions bypass mode either when the ambient temperature is above or below an ambient high temperature threshold or an ambient low temperature threshold, respectively, or when the temperatures of one or more of the one or more electric motors, the one or more batteries, or the one or more motor controllers exceeds or drops below their respective temperature ratings;
wherein, when operating in the extreme environmental conditions bypass mode due to the ambient temperature or the temperatures of one or more of the one or more electric motors, the one or more batteries, or the one or more motor controllers exceeding the respective high temperature thresholds, the one or more controllers are configured to revert to a non-bypassed mode when the temperatures of the one or more electric motors, the one or more motor controllers, or the one or more batteries have dropped below their respective high temperature thresholds; and
wherein, when operating in the extreme environmental conditions bypass mode due to the ambient temperature or the temperatures of the one or more of the one or more electric motors, the one or more batteries, or the one or more motor controllers dropping below the respective low temperature thresholds, the one or more controllers are configured to revert to a non-bypassed mode when the temperatures of the one or more electric motors, the one or more motor controllers, or the one or more batteries have risen above their respective low temperature thresholds due to rising ambient temperatures and/or thermal propagation of heat generated by generator operation.
